(19) United States
(12) Patent Application Publication
(10) Pub. No.: US 2022/0355980 A1
(43) Pub. Date: Nov. 10, 2022

(54) BEAD WORKSTATION AND MAGNETIC DEVICES FOR SORTING BEADS

(71) Applicant: Innovations By Indigo, Inc., West Palm Beach, FL (US)

(72) Inventor: Glenda Paunonen, West Palm Beach, FL (US)

(21) Appl. No.: 17/661,822

(22) Filed: May 3, 2022

Related U.S. Application Data
(60) Provisional application No. 63/185,174, filed on May 6, 2021.

(51) Int. Cl. B65D 25/20; B44C 1/28

(52) U.S. Cl. CPC B65D 25/20; B44C 1/28; B44B 2700/12

(57) ABSTRACT

A magnetic bead sorter and magnetic based bead sorting work station. The magnetic bead sorter is configured to receive and store therein one or more beads. The magnetic bead sorter includes a main body having an upper end and a lower end. The main body may be defined by a continuous side wall having a side wall exterior surface and a side wall interior surface. The continuous side wall encircles a magnetic bead sorter inner surface, thus defining an interior region configured to receive and store beads therein.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/185,174, entitled “BEAD WORKSTATION AND MAGNETIC DEVICES FOR SORTING BEADS”, filed May 6, 2021. The content of the above referenced application is incorporated herein by reference in its entirety.

### FIELD OF THE INVENTION

The present invention relates to a beading project workspace system; and more particularly, to magnetic devices and systems for keeping beads sorted, creating ease of use when working with designs, patterns and projects.

### BACKGROUND OF THE INVENTION

Beadwork, or the art of attaching beads to one another to create objects, such as various types of jewelry or other articles of personal decoration, is well known. During the process of creating a beaded object, beads are attached to one another to create such objects using various techniques, such as stringing, weaving, sewing, or bonding. Designs range from the very simple objects having simple configurations, using few beads, up to complicated objects having extravagant designs and using many beads of different types and colors.

One of the problems a beader, or bead weaver may encounter when creating elaborate works is the ability to efficiently maintain the many numerous beads that may be required in creating complex beaded objects. Bead matts utilizing cut out sections are often used to place differently sized or colored beads into individual pods or sections. While this may help organize the beads into proper areas, such sorting devices suffer from several shortcomings. Soft mats like these can be cumbersome to move around, often result in beads being mixed together, and make clean up difficult. Other devices such as a dish with several compartments, provide separation, however lack easy clean up, and are often too deep or shallow to pick up the individual beads with a needle effectively. Separate containers are often too deep, or too big, and in addition, when attempting to grab or pick up a bead, such containers often slide around, making the process more difficult and slower. The beader is often required to use two hands, one to hold the container, and one to pick up the beads. What is needed is a more efficient beading project workstation, and devices to hold and keep beads available to use. The present invention relates to a system for bead weavers and designers to overcome the shortcomings of known bead sorting containers, mats and boards.

### SUMMARY OF THE INVENTION

The present invention is directed towards a magnetic bead sorter and to a bead weaver project workstation having magnetic, movable, individual bead sorting cup(s). The bead weaver project workstation is designed to keep beads separated and provide easy bead pickup during project use, as well as clean up after use. The bead weaver project workstation is designed to be portable. The magnetic bead sorter is configured to receive and store therein one or more beads. The magnetic bead sorter may include a main body having an upper end and a lower end. The main body may be defined by a continuous side wall having a side wall exterior surface and a side wall interior surface. The continuous side wall encircles a magnetic bead sorter inner surface, thus defining an interior region configured to receive and store beads therein. The magnetic bead sorter is configured to engage with and move about a magnetic board.

The magnetic bead sorter and bead weaver project workstation creates a clean neat workspace that is easily set up, and movable from one room to the next, or one bead station to the next. The magnetic bead sorter and bead weaver project workstation allows for quick set up and quick clean up. In using the magnetic bead sorter and bead weaver project workstation, beads are kept separate and identified which is important when working with a bead pattern. Use of the magnetic bead sorter and bead weaver project workstation provides individual cups on a rigid board, thus keeping beads separate and not mixed together. The magnetic bead sorter provides the right amount of resistance when using a needle or a finger to pick up beads. The magnetic bead sorters are designed move around the magnetic board for easy access as opposed to fixed cavities. Individual magnetic bead sorters allow for customization as to quantity of colors and space needed versus fixed cavities of which not all are needed, or no cavities in which beads get mixed up. Size of the magnetic bead sorters makes working with patterns with many colors (30-60) an effortless possibility.

Accordingly, it is an objective of the instant invention to provide a magnetic bead sorter.

It is a further objective of the invention to provide a magnetic bead sorter configured to provide optimal pick up and prevent beads, from flipping out.

It is yet another objective of the invention to provide a magnetic bead sorter configured to aid a user in picking up and moving the device.

It is a still further objective of the invention to provide a magnetic bead sorter configured to engage with a magnetic board.

It is a further objective of the invention to provide a magnetic bead sorter configured to move about a magnetic board.

It is yet another objective of the invention to provide a magnetic bead sorter configured to move about a magnetic board in multiple directions.

It is a still further objective of the invention to provide a magnetic bead sorter which includes a magnet which provides sufficient resistance and stability, so when the user is picking up beads stored within the magnetic bead sorter, the magnetic bead sorter is not pushed around or moved.

It is a further objective of the invention to provide a magnetic bead sorter comprising a lip.

It is yet another objective of the invention to provide a magnetic bead sorter comprising a lip having an outer portion or outer edge, preferably rounded, that extends out from a main body continuous side wall and away from an interior magnetic bead sorter interior region.

It is a still further objective of the invention to provide a magnetic bead sorter comprising a lip having an inner portion or inner edge, preferably rounded, that extends out from a main body continuous side wall, towards an interior magnetic bead sorter interior region.

It is a further objective of the invention to provide a magnetic bead sorter workstation kit.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a front side perspective view of an illustrative embodiment of a magnetic bead sorter;

FIG. 2A is a rear side perspective view of the magnetic bead sorter;

FIG. 2B is an alternative rear view of the magnetic bead sorter;

FIG. 2C illustrates the magnetic bead sorter having two independent magnets arranged 180 degrees apart;

FIG. 2D illustrates the magnetic bead sorter having four independent magnets;

FIG. 3A is a top perspective view of the magnetic bead sorter;

FIG. 3B is a cross-sectional view of the magnetic bead sorter taken along lines 3B-3B in FIG. 3A;

FIG. 4A illustrates the magnetic bead sorter with beads;

FIG. 4B illustrates the magnetic bead sorter in in use, illustrating a needle shown picking up beads stored within the magnetic bead sorter;

FIG. 5A illustrates an embodiment of the magnetic bead sorter with an upper edge surface;

FIG. 5B illustrates an embodiment of the magnetic bead sorter having a wall formed within the lip and extending up above the lip surface;

FIG. 6 is an embodiment of the magnetic bead sorter shown with accessory items;

FIG. 7 illustrates a plurality of different sized magnetic bead sorters placed on a magnetic board;

FIG. 8 is a top view of the magnetic bead sorter without a lip;

FIG. 9 is a bottom view of the magnetic bead sorter illustrated in FIG. 8;

FIG. 10 is a top perspective view of the magnetic bead sorter illustrated in FIG. 8;

FIG. 11 is an alternative top perspective view of the magnetic bead sorter illustrated in FIG. 8;

FIG. 12 is a bottom perspective view of the magnetic bead sorter illustrated in FIG. 8;

FIG. 13 is a left side view of the magnetic bead sorter illustrated in FIG. 8;

FIG. 14 is a right side view of the magnetic bead sorter illustrated in FIG. 8; and

FIG. 15 illustrates an embodiment of a magnetic bead sorter kit.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

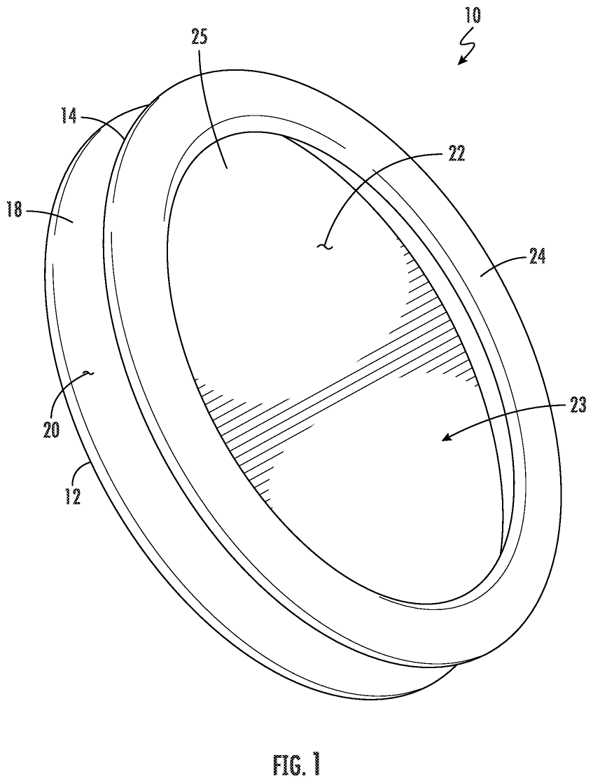

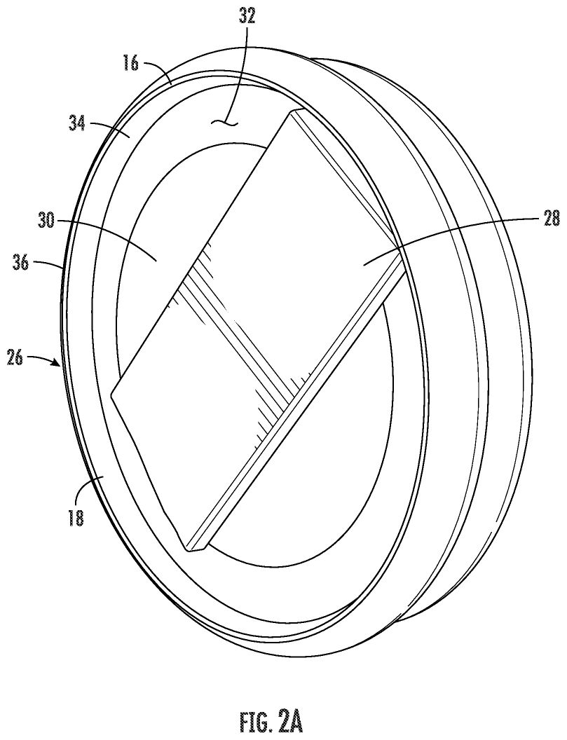

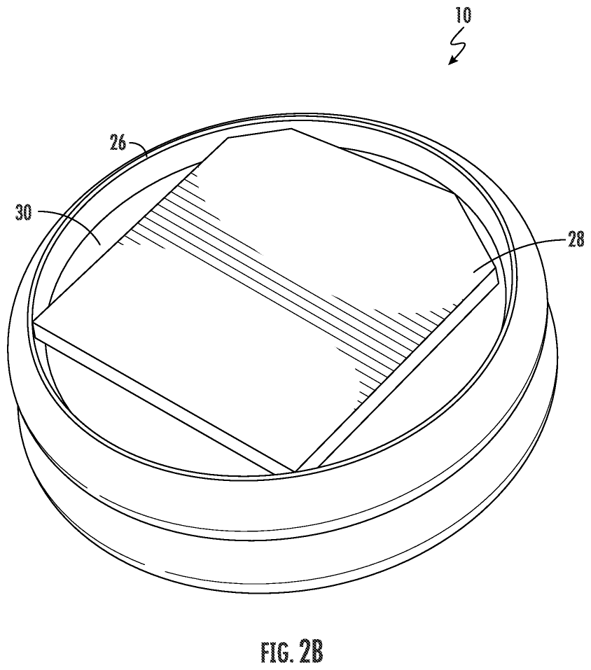

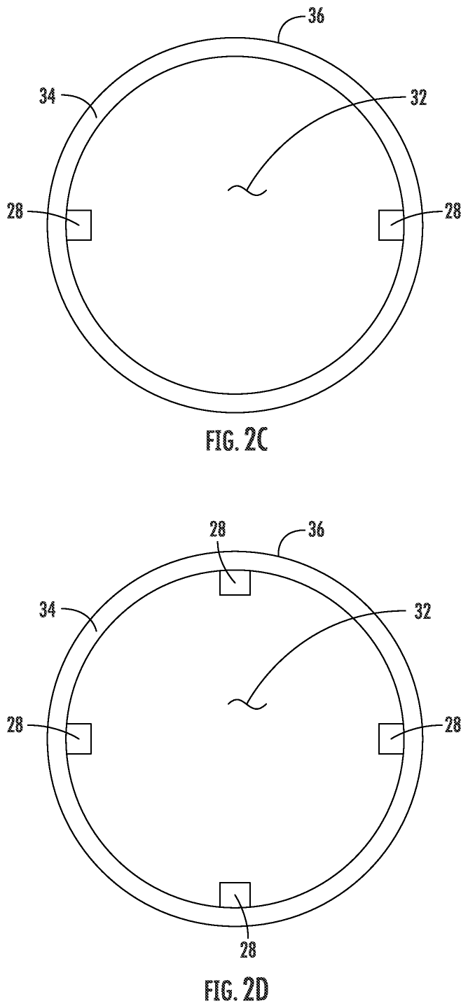

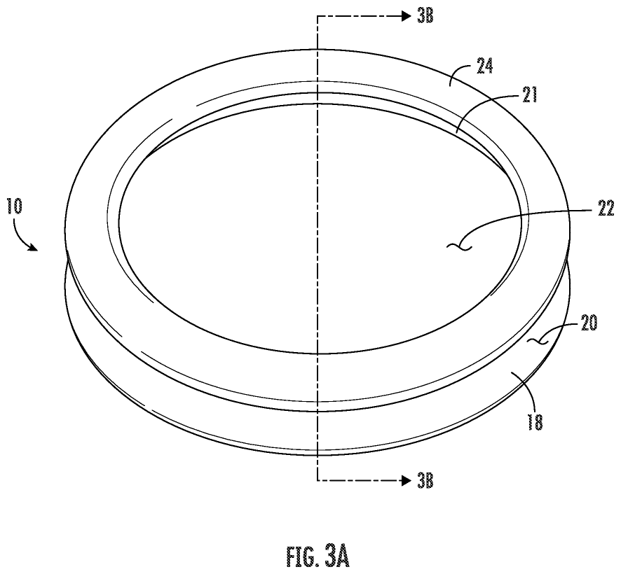

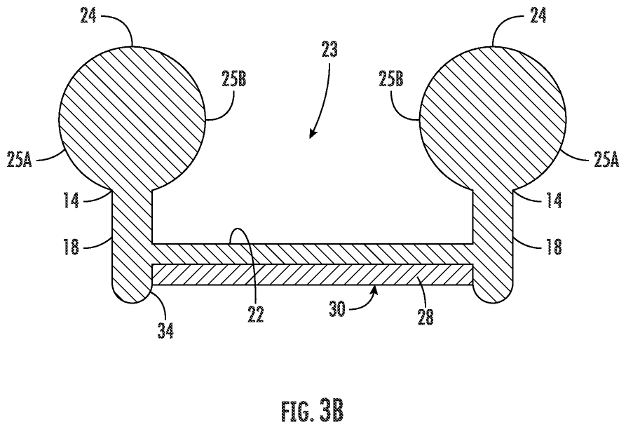

Referring to FIGS. 1 and 2A, an illustrate example of a magnetic bead sorter, referred to herein as magnetic bead sorter 10, is shown. The magnetic bead sorter 10 is configured to receive and store therein one or more beads. The magnetic bead sorter 10 may include a main body 12 having an upper end 14 and a lower end 16. The main body 12 is defined by a continuous side wall 18 having a side wall exterior surface 20 and a side wall interior surface 21 (see FIG. 3A). The continuous side wall 18 encircles a magnetic bead sorter inner surface 22 of bottom wall or floor 25, thus defining an interior region 23. The magnetic bead sorter inner surface 22 may be made of a soft mat material, such as soft absorbent foam materials, solid rubber, cellular foam rubber, polyethylene foam, ethylene-vinyl acetate (EVA) foam, vinyl foam.

The magnetic bead sorter main body upper end 14 includes a lip 24. The lip 24 extends around the entire perimeter of the magnetic bead sorter main body 12 and may assume a rounded, tubular shape. The lip 24 may be sized to extend out past the main body continuous side wall 18. Referring to FIG. 3B, the lip 24 is shown having an outer portion or outer edge 25A, preferably rounded, that extends out from the main body continuous side wall 18 and away from the interior magnetic bead sorter interior region 23. The lip 24 also includes an inner portion or inner edge 25B, preferably rounded, that extends out from the main body continuous side wall 18, towards the interior magnetic bead sorter interior region 23. The lip outer edge 25A is sized and shaped to aid a user in picking up and moving the magnetic bead sorter 10. The lip inner edge 25B is sized, shaped, and/or extends out a sufficient distance from the continuous side wall 18 to prevent beads (when stored in the bead sorter interior region 23) from flipping out. The lip 24 may be made of a plastic material or plastic foam material, such as vinyls, polystyrene, polyethylene, phenolics, silicones, cellulose acetate, and urethanes.

The magnetic bead sorter 10 is configured to secure and move about a magnetic board. A bottom portion 26 of the magnetic bead sorter 10 is adapted to receive and hold therein a magnet 28 (illustrated assuming an elongated bar shape), see FIG. 2A. The bottom portion 26 of the magnetic bead sorter 10 includes a bottom portion interior 30 which includes a surface 32 surrounded by a bottom portion interior wall surface 34. The distance from the bottom portion interior surface 32 to the edge 36 of the bottom of the main body continuous side wall 18 is of sufficient size to enclose, and therefore hold, the magnet 28 in place. Preferably, the magnet 28 rests within the bottom portion interior 30, resting on the bottom portion interior surface 32, at or under the edge 36 of the bottom of the main body continuous side wall 18. Such positioning allows the magnet 28 to 1) securely fit within the bottom portion interior 30, 2) remain within the bottom portion interior 30 during use, and 3) rest or sit flush with a magnetic board when the magnetic bead sorter 10 is placed thereon and moved around. FIG. 2B illustrates the magnet 28 assuming more of a square shape. The magnetic bead sorter 10 may be configured to include multiple, individual magnets 28. FIG. 2C illustrates the magnetic bead sorter 10 having two independent magnets 28 arranged one-hundred eighty (180) degrees apart. FIG. 2D illustrates the magnetic bead sorter 10 having four independent magnets 28.

The magnet 28 may be any magnetic material known to one of skill in the art, including ferrite magnets, neodymium (NdFeB) magnets, Samarian Cobalt (SmCo) magnets, or Aluminum nickel cobalt (AlNiCo) magnets. The magnet 28 may be secured within the bottom portion 26 of the magnetic bead sorter 10 by chemical fastening members, such as glue or other chemical fastening solutions. Alternatively, the magnet 28 may be secured within the bottom portion 26 using mechanical fastening mechanisms, such as frictional fit, use of brackets and screws, or flexible ribs.

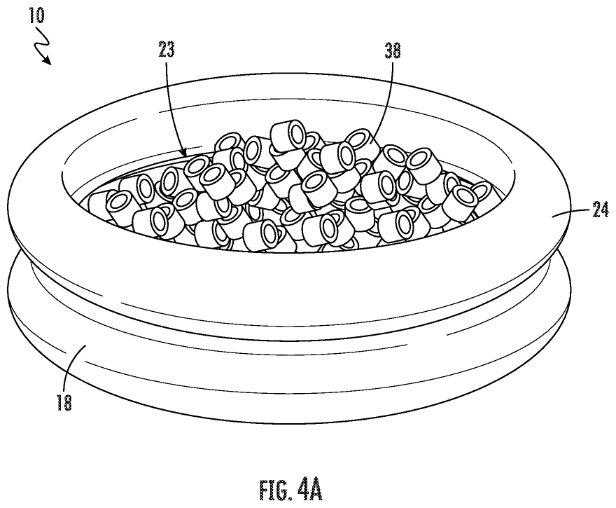

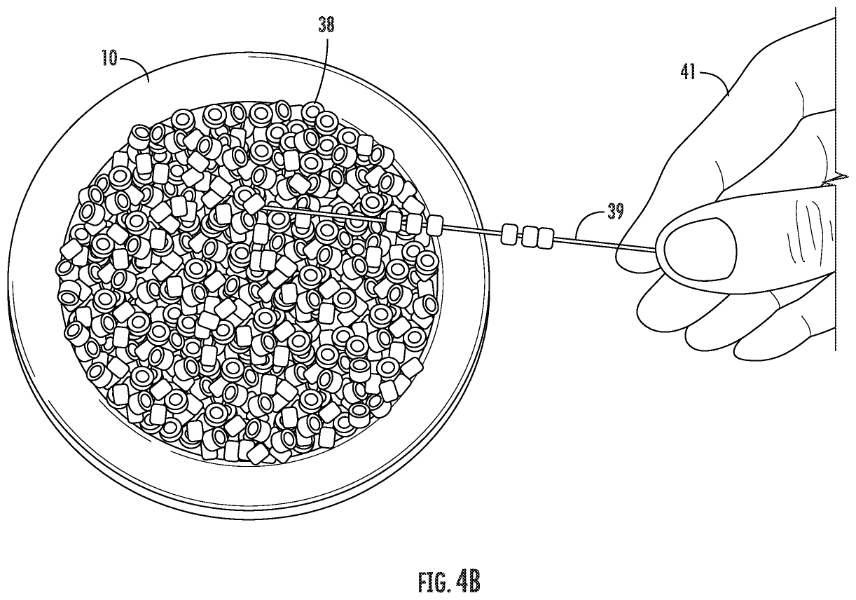

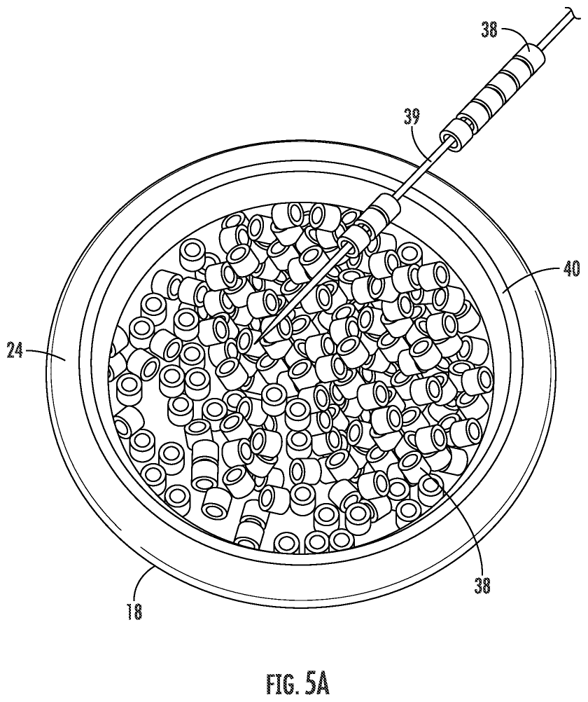

Referring to FIG. 4A, the magnetic bead sorter 10 is shown with a plurality of decorative beads 38 placed and stored within the interior magnetic bead sorter interior region 23 ready for use. The magnetic bead sorter 10 may be sized according to the type or size of beads to be stored therein. In an illustrative example, the magnetic bead sorter 10 may be sized having a diameter of between 1⅛^{th} (1.125) to 1¾ (1.75) inches, around ⅜ (0.375) to ½ (0.5) inches tall, and have a bead depth of about 3/16 (0.1875) inch. The bottom portion may be approximately 1/16 inch deep. As used within the specification, the terms “about” or “around”, or “approximately” refer to a value 10% to 20% above or below the stated value. In addition to various sizes, the magnetic bead sorter 10 may be colored, i.e., red, blue, green, to aid the user in visually determining what types or sized beads are laid out for use therein.

Referring to FIG. 4B, the magnetic bead sorter 10 is shown in use. A needle 39, held in place by a user's fingers 41, is shown being used to pick up beads 38 (smaller sized beads than illustrated in FIG. 4A) situated within the magnetic bead sorter 10.

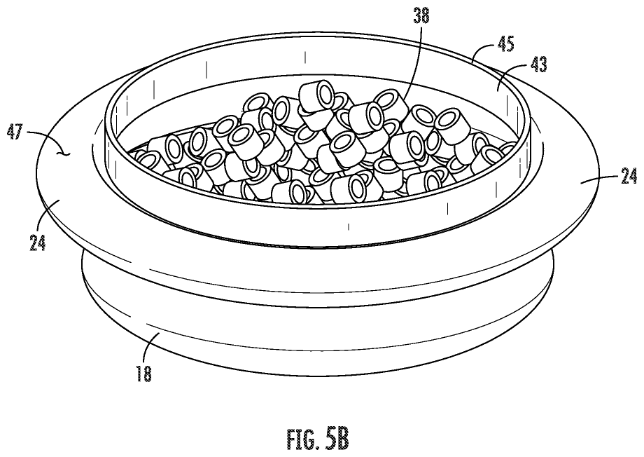

Referring to FIG. 5A, the magnetic bead sorter 10 may include an upper surface edge 40. The upper surface edge 40, preferably a flat edge, may extend around the entire perimeter of the magnetic bead sorter 10. The upper surface edge 40 may be configured to provide a flat surface within the rounded lip 24, allowing a user to use the upper surface edge 40 to slide off extra beads when picking up too many on a needle.

Referring to FIG. 5B, the magnetic bead sorter 10 may include a wall 43 having an upper surface 45. The wall 43 may be formed within the lip 24, extending up above the lip surface 47. The wall 43 preferably extends around the entire perimeter of the lip 28 and may allow the user to scratch off beads when picking up too many or extra beads on a needle. The upper surface 45 is preferably, but need not be, flat.

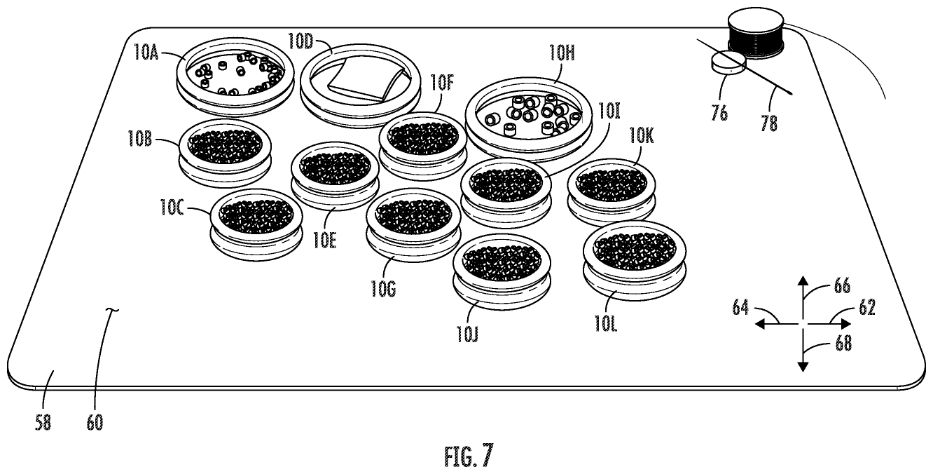

FIG. 7 illustrates multiple magnetic bead sorters 10, referred to individually as magnetic bead sorter 10A-10L. Each of the magnetic bead sorters 10A-10L having the same structural features, differing in size and/or color. As illustrated, the multiple magnetic bead sorters 10A-10L are placed on a magnetic board 58 creating a project workstation. The magnetic board 58 allows the magnetic bead sorter 10 to engage with and magnetically secure to the surface 60. Because the magnet 28 sits at or under the edge 36 of the bottom of the main body continuous side wall 18, thus remaining flush with the edge 36 of the bottom of the main body continuous side wall 18, the magnetic bead sorter 10 is movable in multiple directions: left direction, see arrow 62, right direction, see arrow 64, up direction, see arrow 66, down direction, see arrow 68, or combinations thereof, on the magnetic board 58. Although the magnetic bead sorter 10 is configured to be movable about the magnetic board 58, the magnet 28-magnetic board 58 interaction should be of sufficient strength to 1) allow the magnetic bead sorter 10 to move about the magnetic board 58, and 2) provide sufficient resistance and stability so that, when the user is picking up beads 38 stored within the magnetic bead sorter 10, the magnetic bead sorter 10 is not pushed around or moved.

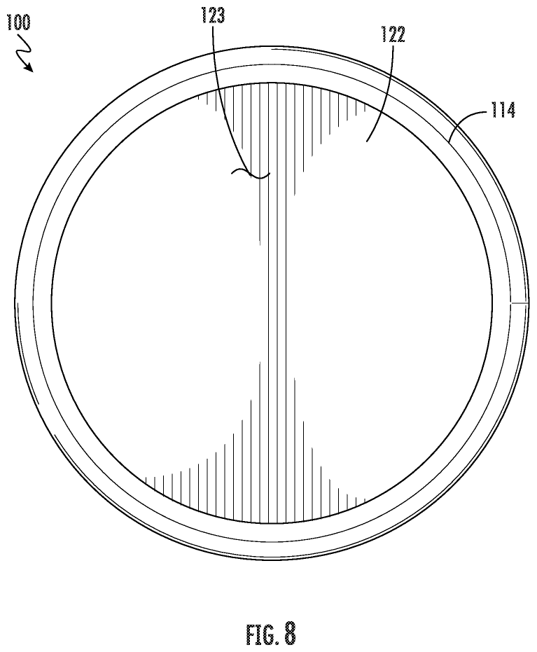

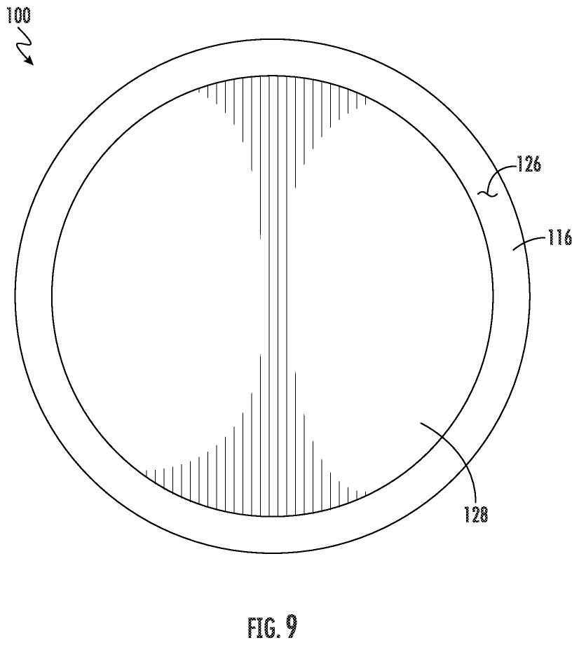

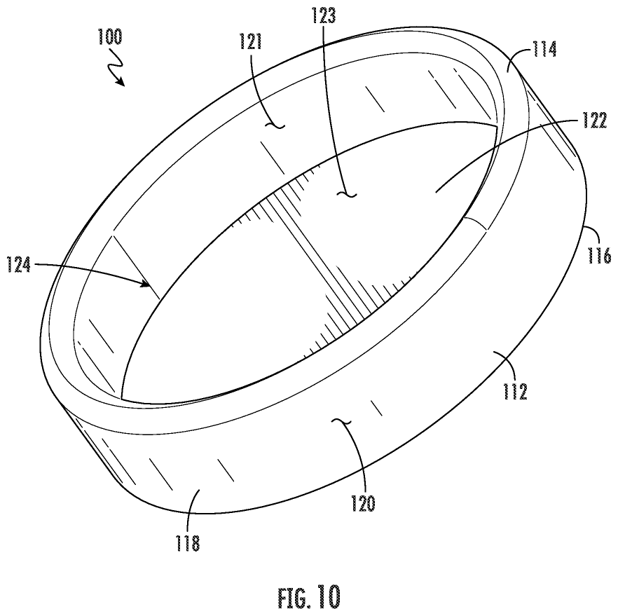

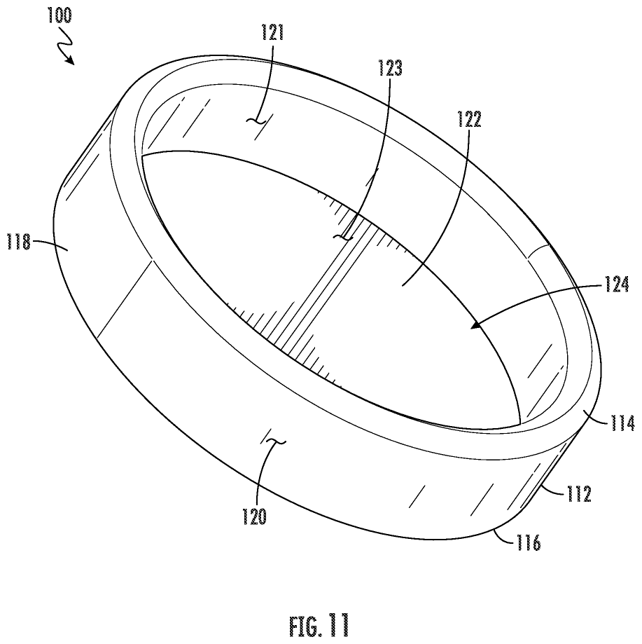

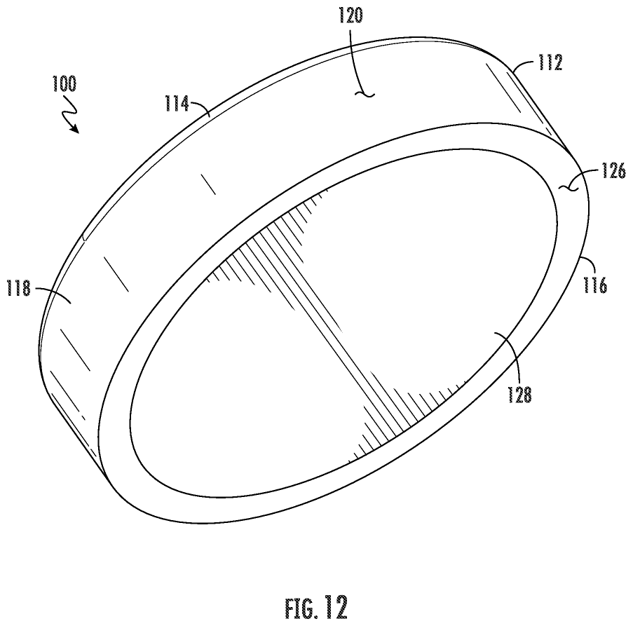

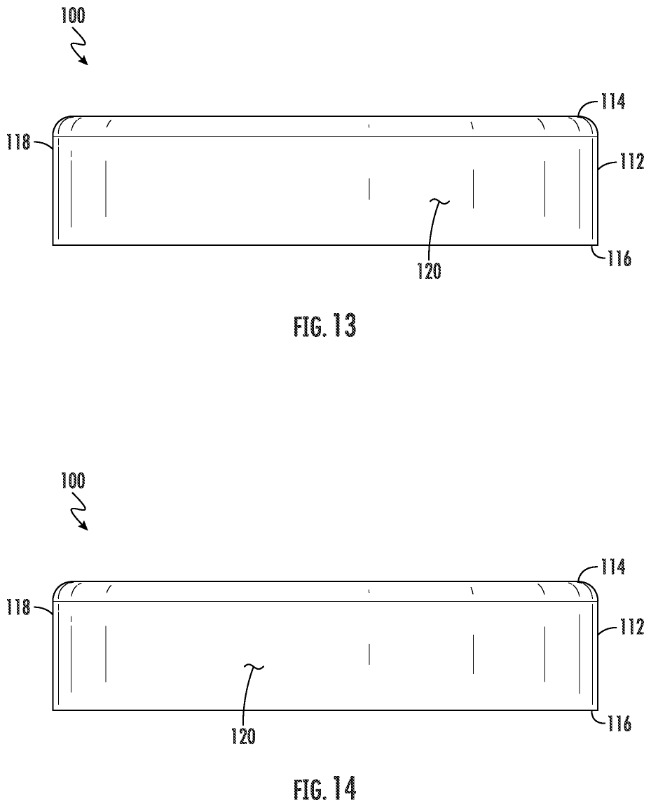

Referring to FIGS. 8-15, an illustrative embodiment of the magnetic bead sorter, referred to generally as magnetic bead sorter 100, is shown without a lip. Accordingly, the magnetic bead sorter 100 has many of the same structural components, having the same fucntions as that described for the magnetic bead sorter 10, without having the lip 24. Accordingly, the magnetic bead sorter 100 is configured to receive and store therein one or more beads. The magnetic bead sorter 100 may include a main body 112 having an upper end 114 and a lower end 116. The main body 112 is defined by a continuous side wall 118 having a side wall exterior surface 120 and a side wall interior surface 121. The continuous side wall 118 encircles a magnetic bead sorter bottom wall or floor 122 having an inner surface 123, thus defining an interior region 124. Preferably, the continuous side wall 118 is arranged at a right angle, or 90 degrees or about 90 degrees to the bottom wall or floor 122. The magnetic bead sorter bottom wall or floor 122, or portions thereof, may be made of a soft mat material, such as soft absorbent foam materials, solid rubber, cellular foam rubber, polyethylene foam, ethylene-vinyl acetate (EVA) foam, vinyl foam. magnetic bead sorter bottom wall or floor 122 may have a sticker (for example made of white vinyl or matte lamination) secured thereto via adhesive. The magnetic bead sorter 100 is configured to secure and move about a magnetic board. A bottom surface 126 of the magnetic bead sorter 100 includes a magnet 128, thus forming and defining a magnetic surface. The magnet 128 is secured to the bottom surface 126 of magnetic bead sorter bottom wall or floor 122 via chemical fastening, such as through the use of glue. Alternative mechanisms of securing the magnet 128 to the bottom surface 126, such as mechanical fastening members, i.e. screws, or frictional fitting, known to one of skill in the art may also be used. The magnet 128 (as well as magnet 28) may assume or cover 100% of the bottom surface 126, less than 100% of the bottom surface 126, such as 95%, 90%, 85%, 80%, 75%, 70%, 65%, 60%, 55%, 50%, less than 50% of the bottom surface 126, such as 45%, 40%, 35%, 30%, 25%, 20%, 15%, 10%, 5%, or any value in between.

While the magnetic bead sorter 100 is shown having a single magnet 128, it may be configured to have two or more magnets 128. Magnet 128 may be any magnetic material known to one of skill in the art, including ferrite magnets, neodymium (NdFeB) magnets, Samarian Cobalt (SmCo) magnets, or Aluminum nickel cobalt (AlNiCo) magnets. The strength of the magnet 128 (or 28), when placed on a magnetic board, should be of a strength to provide sufficient resistance to movement, i.e. prevent (or minimize) the magnetic bead sorter 100 (10) from moving when on the magnetic board 58 when a user inserts a beading needle therein to pick up one or more beads (a first force), i.e. into the interior region 124 (or 23) to pick up one or more beads stored therein, yet allow the magnetic bead sorter 100 (10) to be moved and placed in different locations on the magnetic board 58 (preferably remaining on the magnetic board 58 but slid to different positions) when a second or larger force is applied. As an illustrative example, magnet 128 (or 28) may be 30 mill, with a pull strength of 8.5 lbs. per linear foot. Magnet 128 (or 28) may be made with 16 pulls per inch.

As described above for the magnetic bead sorter 10, the magnetic bead sorter 100 may also be sized according to the type or size of beads to be stored therein. In an illustrative example, the magnetic bead sorter 100 maybe sized having a diameter of between about 1⅛^{th} (1.125) to about 1¾ (1.75) inches, around ⅜(0.375) to around ½ (0.5) inches tall, and have a bead depth of about 3/16 (0.1875) inch. In addition to various sizes, the magnetic bead sorter 100 may be colored, i.e., red, blue, green, to aid the user in visually determining what types or sized beads are laid out for use therein.

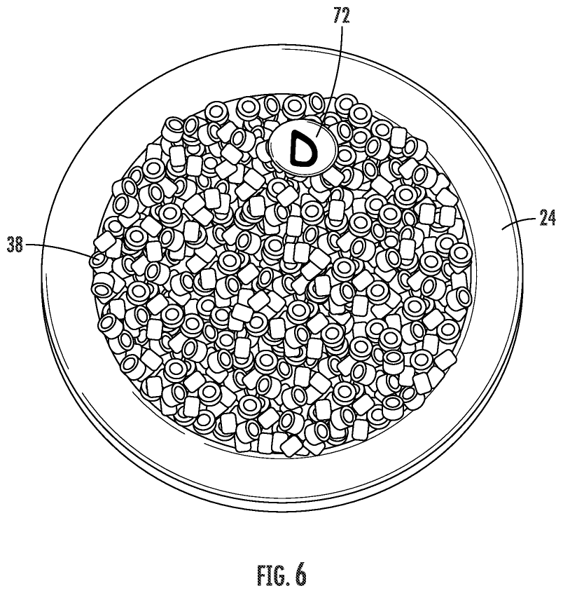

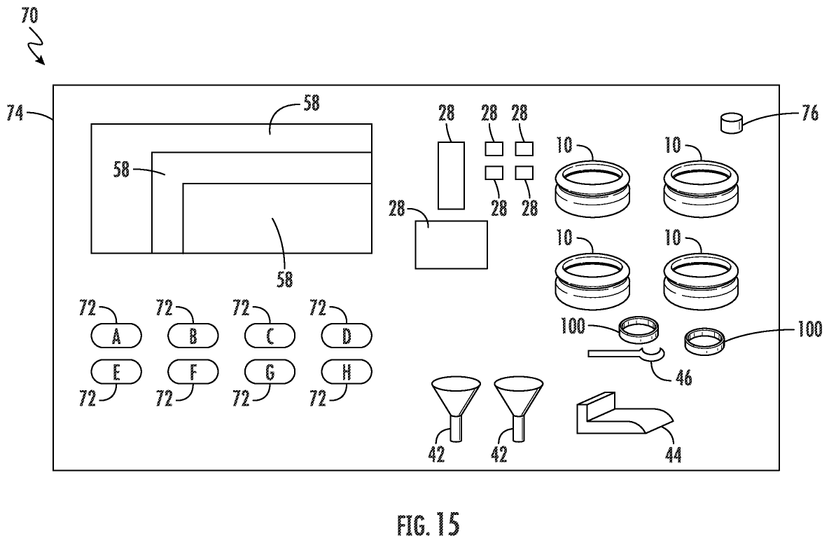

Referring to FIG. 15, a magnetic bead sorter workstation kit 70 is shown. The kit 70 may include one or more, in any combination, of: 1) one or more magnetic bead sorter 10 (same sizes, different sizes, different colors) or one or more magnetic bead sorter 100 (same sizes, different sizes, different colors), or combinations thereof; 2) one or more magnetic boards (same or different sizes) 58; 3) one or more magnets 28 (different sizes or shapes); 4) one or more bead funnels 42; 5) one or more bead shovel 44 or scoop or spoon 46; and 6) one or more identifying markers 72. The one or more identifying marker 72 may be a colored bead or a bead with an alphabetical letter (see FIG. 6), number, symbol, picture, pattern, or other types of indicia, or combinations thereof. The identifying markers 72 may be placed within the magnetic bead sorter 10, see FIG. 5, providing the user with a quick visual reference as to what the bead is in relationship to the bead design or pattern. The contents of the kit 70 may be stored in a housing member 74, such as a container or bag. The magnetic bead sorter workstation kit 70 may also include one or more needle magnets 76 for securing a needle 78, see also FIG. 7. Each of the individual components, when used together or separately, form a magnetic based beaders/beading workstation.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A magnetic bead sorter configured to receive and store therein one or more beads, comprising:
a main body having an upper end and a lower end, a continuous side wall having a side wall exterior surface and a side wall interior surface;
a bottom wall having an inner surface encircled by said continuous side wall, thus defining an open interior region, and an outer surface; and
a magnetic surface.

2. The magnetic bead sorter configured to receive and store therein one or more beads according to claim 1, wherein said magnetic surface is secured to said bottom wall outer surface.

3. The magnetic bead sorter configured to receive and store therein one or more beads according to claim 1, wherein said magnetic surface, when placed on a magnetic board, comprises a sufficient magnetic strength to prevent or provide resistance to movement when a first force is applied thereto, but allow said magnetic bead sorter to be moved and placed in different location(s) along said magnetic board when a larger second force is applied.

4. The magnetic bead sorter configured to receive and store therein one or more beads according to claim 1, where said bottom wall inner surface is made from a soft mat material.

5. The magnetic bead sorter configured to receive and store therein one or more beads according to claim 4, wherein said bottom wall inner surface soft mat material is a soft absorbent foam material, solid rubber, cellular foam rubber, polyethylene foam, ethylene-vinyl acetate (EVA) foam, or vinyl foam.

6. The magnetic bead sorter configured to receive and store therein one or more beads according to claim 1, wherein said magnetic bead sorter main body upper end includes a lip.

7. The magnetic bead sorter configured to receive and store therein one or more beads according to claim 1, wherein said magnetic bead sorter has a diameter of between about 1.125 inches to about 1.75 inches.

8. The magnetic bead sorter configured to receive and store therein one or more beads according to claim 1, wherein said magnetic bead sorter has a height of between about 0.375 inches to about 0.5 inches.

9. The magnetic bead sorter configured to receive and store therein one or more beads according to claim 1, wherein said magnetic bead sorter has a bead depth of about 0.1875 inch.

10. A magnetic based bead sorting work station, comprising:
at least one magnetic bead sorter, said at least one magnetic bead sorter configured to receive and store therein one or more beads, and comprising, a main body having a continuous side wall having a side wall exterior surface and a side wall interior surface, a bottom wall having an outer surface and an inner surface encircled by said continuous side wall, thus defining an open interior region, and a magnetic surface;
at least one magnetic board;
at least one of a bead funnel, a bead shovel, a bead scoops, an bead spoon, or combinations thereof; and
at least one identifying marker.

11. The magnetic based bead sorting work station according to claim 10, further comprising multiple magnetic bead sorters having the same size, shape, or color.

12. The magnetic based bead sorting work station according to claim 10, further comprising multiple magnetic bead sorters having different sizes, shapes, or color.

13. The magnetic based bead sorting work station according to claim 10, wherein the at least one identifying marker is sized and shaped to fit within said at least one magnetic bead sorter.

14. The magnetic based bead sorting work station according to claim 10, wherein said at least one identifying marker is a colored bead.

15. The magnetic based bead sorting work station according to claim 10, wherein said at least one identifying marker is a bead having indicia.

16. The magnetic based bead sorting work station according to claim 15, wherein said indicia includes an alphabetical letter, a number, a symbol, a picture, a pattern, or combinations thereof.

17. The magnetic based bead sorting work station according to claim 10, further comprising multiple magnetic boards each having a sufficient size and shape to hold at least one said at least one magnetic bead sorter.

18. The magnetic based bead sorting work station according to claim 10, wherein said at least one magnetic bead sorter comprises a magnetic surface, which when placed on a magnetic board, comprises a sufficient magnetic strength to prevent or provide resistance to movement when a first force is applied thereto, but allow said magnetic bead sorter to be moved and placed in different location(s) along said magnetic board when a larger second force is applied.
